(19) United States
(12) Patent Application Publication
(10) Pub. No.: US 2008/0253226 A1
(43) Pub. Date: Oct. 16, 2008

(54) System and method for marine seismic surveying

(76) Inventors: Stig Rune Lennart Tenghamn, Katy, TX (US); Claes Nicolai Borresen, Katy, TX (US)

Correspondence Address: E. Eugene Thigpen;Petroleum Geo-Services, Inc., P.O. Box 42805, Houston, TX, 77242-2805, US

(21) Appl. No.: 11/786,115

(22) Filed: Apr. 11, 2007

(51) Int. Cl. G01V 1/38

(52) U.S. Cl. 367/21

(57) ABSTRACT

A system for marine seismic surveying comprises at least one marine seismic streamer; at least one pressure sensor mounted in the at least one marine seismic streamer; at least one particle motion sensor mounted in the at least one marine seismic streamer and collocated with the at least one pressure sensor, wherein the at least one particle motion sensor has a resonance frequency above 20 Hz; and computer means for combining pressure data from the at least one pressure sensor and particle motion data from the at least one particle motion sensor for further processing.

### CROSS-REFERENCES TO RELATED APPLICATIONS

Not Applicable

### FEDERALLY SPONSORED RESEARCH OR DEVELOPMENT

Not Applicable

### SEQUENCE LISTING, TABLE, OR COMPUTER LISTING

Not Applicable

### BACKGROUND OF THE INVENTION

1. Field of the Invention

This invention relates generally to the field of geophysical prospecting and particularly to the field of marine seismic surveying.

2. Description of the Related Art

In the oil and gas industry, geophysical prospecting is commonly used to aid in the search for and evaluation of subterranean formations. Geophysical prospecting techniques yield knowledge of the subsurface structure of the earth, which is useful for finding and extracting valuable mineral resources, particularly hydrocarbon deposits such as oil and natural gas. A well-known technique of geophysical prospecting is a seismic survey. In a land-based seismic survey, a seismic signal is generated on or near the earth's surface and then travels downwardly into the subsurface of the earth. In a marine seismic survey, the seismic signal may also travel downwardly through a body of water overlying the subsurface of the earth. Seismic energy sources are used to generate the seismic signal which, after propagating into the earth, is at least partially reflected by subsurface seismic reflectors. Such seismic reflectors typically are interfaces between subterranean formations having different elastic properties, specifically wave velocity and rock density, which lead to differences in elastic impedance at the interfaces. The reflections are detected by seismic sensors at or near the surface of the earth, in an overlying body of water, or at known depths in boreholes. The resulting seismic data are recorded and processed to yield information relating to the geologic structure and properties of the subterranean formations and their potential hydrocarbon content.

Appropriate energy sources may include explosives or vibrators on land and air guns or marine vibrators in water. Appropriate types of seismic sensors may include particle velocity sensors in land surveys and water pressure sensors in marine surveys. Particle velocity sensors are commonly know in the art as geophones and water pressure sensors are commonly know in the art as hydrophones. Both seismic sources and seismic sensors may be deployed by themselves or, more commonly, in arrays.

In a typical marine seismic survey, a seismic survey vessel travels on the water surface, typically at about 5 knots, and contains seismic acquisition equipment, such as navigation control, seismic source control and seismic sensor control equipment, and recording equipment. The seismic source control equipment causes a seismic source towed in the body of water by the seismic vessel to actuate at selected times. Seismic streamers, also called seismic cables, are elongate cable-like structures that are towed by the seismic survey vessel that tows the seismic source or by another seismic survey ship. Typically, a plurality of seismic streamers is towed behind a seismic vessel. The seismic streamers contain sensors to detect the reflected wavefields initiated by the seismic source and reflected from reflecting interfaces. Conventionally, the seismic streamers contain pressure sensors such as hydrophones, but seismic streamers have been proposed that contain water particle motion sensors such as geophones, in addition to hydrophones. The pressure sensors and particle velocity sensors may be deployed in close proximity, collocated in pairs or pairs of arrays along a seismic cable.

The pressure and particle motion sensors detect waves traveling upward in the water after reflection from the interfaces between subterranean formations. These waves, known as primary waves, contain the sought after information about the structure of the subterranean formations. The sensors also detect waves traveling downward in the water after reflection from the air-water interface at the water surface. These waves are known generally as secondary waves or “ghosts”.

Both pressure and particle motion waves experience a reversal in polarity at the air-water interface. Thus, pressure sensors, which are omni-directional and hence do not distinguish directions, detect the reversal of phase polarity in ghost waves. However, vertical particle motion sensors, which are directional, do not detect a phase reversal, since the up- and down-going wavefield also have an opposite polarity due to a change in direction and this cancels the polarity change due to reflection at the water-air interface. This polarity difference in sensor detection of ghosts, between pressure and particle motion sensors, can be employed to substantially cancel the ghosts. Therefore, the proper combination of the pressure and particle motion sensor signals can be utilized to deghost marine seismic data.

However, particle motion sensors, such as geophones and accelerometers, are much more susceptible to picking up unwanted noise from mechanical vibrations in the towed streamers than pressure sensors, such as hydrophones. Thus, the simple combination of particle motion and pressure sensor signals result in a low signal-to-noise ratio because of the extra noise in the particle motion sensor. This mechanical streamer noise is typically more evident in the lower frequencies, below 50 Hz.

Various solutions to the noise problem have been proposed. For example, Albert Berni, in his U.S. Pat. No. 4,437,175, “Marine Seismic System”, issued Mar. 13, 1984, describes a system comprising a hydrophone and an integrated accelerometer in a marine seismic streamer. This patent proposes filtering the particle velocity signal from the integrated accelerometer to attenuate lower frequencies before combining with the pressure signal from a hydrophone for further processing. However, there has not been any commercial implementation of a streamer cable that utilizes both particle motion and pressure sensor.

Thus, a need exists for a system for marine seismic surveying that includes a particle motion sensor, such as a geophone, that is less susceptible to low frequency noise. Such a sensor would be useful for employment in conjunction with pressure sensors, such as hydrophones, in marine seismic streamers for attenuating mechanical streamer noise to improve signal-to-noise ratio.

### BRIEF SUMMARY OF THE INVENTION

In one embodiment, the invention is a system for marine seismic surveying, comprising: at least one marine seismic streamer; at least one pressure sensor mounted in the at least one marine seismic streamer; at least one particle motion sensor mounted in the at least one marine seismic streamer and collocated with the at least one pressure sensor, wherein the at least one particle motion sensor has a resonance frequency above 20 Hz; and computer means for combining pressure data from the at least one pressure sensor and particle motion data from the at least one particle motion sensor for further processing.

In another embodiment, the invention is a method for marine seismic surveying, comprising: towing at least one marine seismic streamer; acquiring pressure data from at least one pressure sensor mounted in the at least one marine seismic streamer; acquiring particle motion data from at least one particle motion sensor mounted in the at least one marine seismic streamer and collocated with the at least one pressure sensor, wherein the at least one particle motion sensor has a resonance frequency above 20 Hz; and combining the pressure data and the particle motion data for further processing.

### BRIEF DESCRIPTION OF THE DRAWINGS

The invention and its advantages may be more easily understood by reference to the following detailed description and the attached drawings, in which:

FIG. 1 is a graph of frequency response of a geophone according to the present invention;

FIG. 2 is a graph of frequency response of a standard geophone;

FIG. 3 is a graph of frequency response for an accelerometer and three geophones according to the present invention; and

FIG. 4 is a flowchart illustrating the steps of an embodiment of the method of the invention for marine seismic surveying.

While the invention will be described in connection with its preferred embodiments, it will be understood that the invention is not limited to these. On the contrary, the invention is intended to cover all alternatives, modifications, and equivalents that may be included within the scope of the invention, as defined by the appended claims.

### DETAILED DESCRIPTION OF THE INVENTION

In one embodiment, the invention is a system for marine seismic surveying. The system according to the invention comprises towed marine seismic streamers with pressure sensors and particle motion sensors mounted collocated within the streamer. The pressure sensors are preferably hydrophones and the particle motion sensors are preferably geophones. The particle motion sensors are designed to have a resonance frequency above 20 Hz.

The system of the invention may be employed to record pressure data and particle motion data with the pressure and particle motion sensors, respectively. Then, the pressure data and the particle motion data may be combined, by conventional computer means, as is well known in the art of seismic data processing. Such computer means would include, but would not be restricted to, any appropriate combination or network of computer processing elements including, but not limited to, hardware (processors of any type, temporary and permanent memory, and any other appropriate computer processing equipment), software (operating systems, application programs, mathematics program libraries, and any other appropriate software), connections (electrical, optical, wireless, or otherwise), and peripherals (input and output devices such as keyboards, pointing devices, and scanners, display devices such as monitors and printers, storage media such as disks and hard drives, and any other appropriate equipment).

Geophones are typically electromagnetic devices comprising at least two interacting elements, a coil and a magnet. The coil and the magnet are included within a geophone casing, which is, in turn, connected to the medium through which the seismic signals travel. One of the two elements, either the coil or the magnet, is rigidly affixed to the casing, while the other element is flexibly suspended from the casing. The fixed element then moves with the geophone casing, while the suspended element acts as an inertial mass. Thus, as the medium moves in response to the seismic signal transmitted through it, the fixed element moves integrally with the geophone casing and the medium. The suspended element tends to remain stationary while the casing moves up and down in response to passing seismic waves.

This relative axial movement between the coil and magnet induces an electrical current in the coil as the coil windings cut the lines of magnetic flux from the magnet. The electric current generated in the electric coil is proportional to the rate of change of flux through the coil and forms the geophone output signal, with the voltage being proportional to the velocity of the motion of the fixed element. Typically, the magnet moves with the geophone casing, while the coil acts as the inertial mass. The coil is typically a solenoid coil, an annular winding of electrical wire, and the magnet is typically a permanent magnet. The coil is suspended from the geophone casing by a spring system.

The combination of the suspended element and the spring system has a resonance, or natural, frequency which depends upon the inertial mass and the restoring force of the spring suspension. In a standard electromagnetic geophone, the resonance frequency fᵣ depends upon the mass m of the suspended inertial element, whether coil or magnet, and the stiffness coefficient k of the spring as follows:

$${f}_{r} = \frac{1}{2 π} \sqrt{\frac{k}{m}} . \qquad ( 1 )$$

The spring constant k is the proportionality constant between force acting on the spring and elongation of the spring attributable to that force. The combination of the suspended element and the spring system can be designed so that the spring constant k and inertial mass m give a predetermined resonance frequency fᵣ. Conventionally, geophones with a resonance frequency fᵣ around 10 Hz has been utilized. In the system of the invention, geophones with a resonance frequency fᵣ above 20 Hz are employed. Thus, the spring constant k and the suspended inertial mass m of the geophone of the invention are selected such that the combination yields a resonance frequency fᵣ above 20 Hz.

Additionally, damping of the suspended element is usually introduced to equalize the geophone's response across the frequencies above the resonance frequency. The damping may be obtained by including it as part of the suspension system by, for example, employing a damping resistor acting as a shunt across the electric coil or by immersing the suspended element in a viscous liquid. The damping is usually expressed as a damping coefficient, representing a fraction of the critical damping R_{c} given by:

R_{c}=2\sqrt{km}, (2)

which represents the maximum amount of damping that will just eliminate the oscillatory response of the geophone. A damping coefficient in the range of approximately 0.5 to 0.7 is typically employed. In all of the following examples, a damping coefficient of 0.6 is utilized.

When the frequency of the driving motion from the seismic signal is above the resonance frequency of the geophone, the displacement of the casing, relative to the inertial mass, is equal to and can be utilized as a direct measure of the driving motion, i.e., the seismic signal. Below the resonance frequency, the sensitivity of the geophone falls off at a rate of about −12 dB per octave. Thus, in the system of the invention, the geophones employed have a lower response to the signal and to noise at frequencies below the resonant frequency, and especially in the range of 1-10 Hz, than in the higher frequencies. The lower frequencies are just where noise from mechanical streamer vibration resides. Thus, geophones as employed in the invention will detect and record less of this mechanical noise than conventional geophones used in seismic exploration.

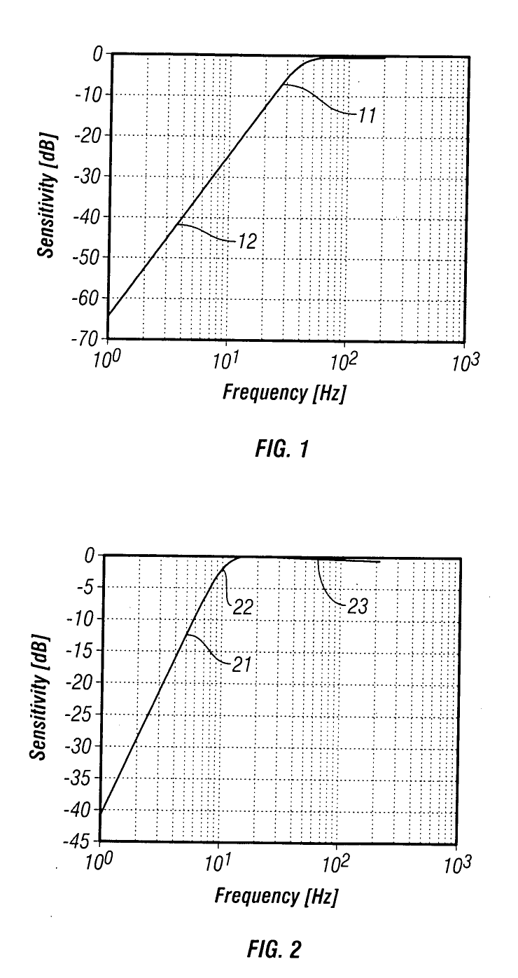

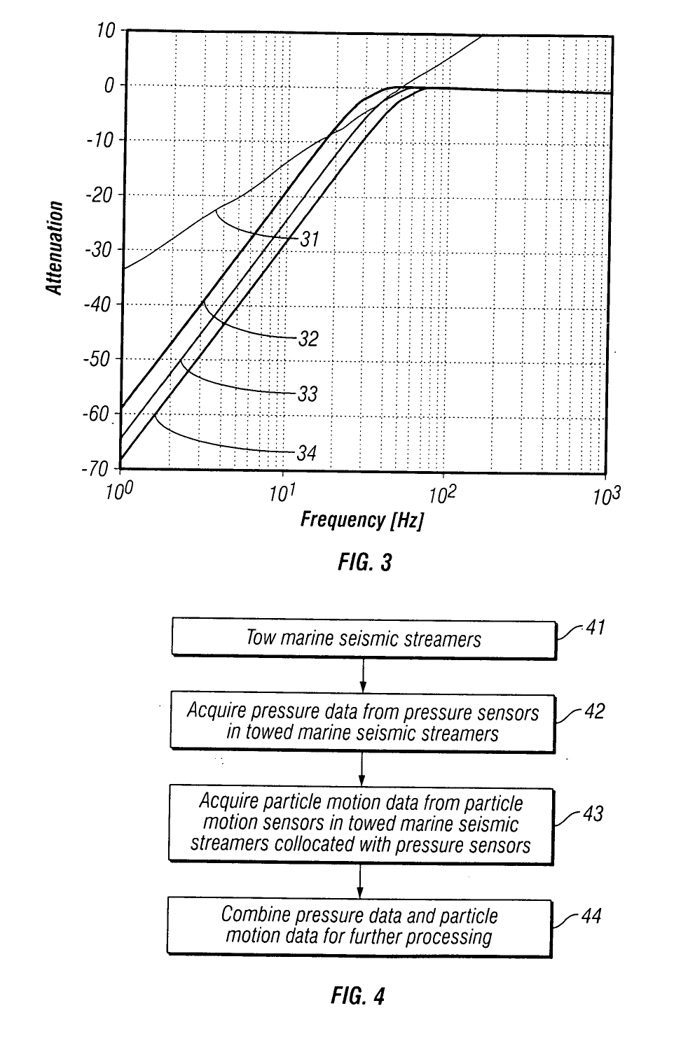

FIG. 1 shows the frequency response of a geophone which could be employed in the system of the invention. FIG. 1 shows the frequency response 11 of a geophone according to the present invention as a graph of sensitivity in dB versus frequency in Hz. This particular geophone in the example has a resonance frequency of 40 Hz, which is above 20 Hz, as specified in the invention. However, geophones with other resonance frequencies, such as will be discussed below in reference to FIG. 3, could also be employed in the system of the invention.

For comparison, consider the response of a standard seismic geophone having a resonance frequency of 10 Hz. FIG. 2 shows the frequency response 21 of this standard geophone as a graph of sensitivity in dB versus frequency in Hz. For this standard geophone, there could be, for example, noise in the frequency response (indicated at numeral 21) at 10 Hz (indicated at numeral 22) that is 60 dB stronger that the measured signal from 50-100 Hz (indicated at numeral 23). Harmonic distortion can also be anticipated at multiples of the noise frequencies. Because of this harmonic distortion, the dynamic range of the digitized output signal and the quality of the signal of interest will be limited.

The frequency response 11 of the geophone according to the invention, shown in FIG. 1, is reduced in the range of 1-10 Hz (indicated at numeral 12) by 20-68 dB, which will have a beneficial effect on available dynamic range and harmonic distortion, as compared to a standard geophone. The slope of the frequency response 11 on the low frequency (indicated at numeral 12) end is normally about −12 dB per octave for a geophone as in the invention.

As discussed above, the geophone of the invention is designed through appropriate selection of the spring constant k and the suspended inertial mass m so that the combination yields a resonance frequency fᵣ above 20 Hz. In particular embodiments, the resonance frequency is selected in the range of 30 to 50 Hz. FIG. 3 shows the frequency responses of three geophones according to the present invention with representative resonance frequencies of 30, 40, and 50 Hz. The graphs of frequency response, indicated by numerals 32, 33, and 34, correspond to resonance frequencies of 30, 40, and 50 Hz, respectively. The geophone with a resonance frequency of 40 Hz (indicated by numeral 33), is the same as shown in FIG. 1.

In a geophone having a resonant frequency of 10 Hz, the detected low frequency noise will have an amplitude that is much higher than the amplitude of the detected seismic signal. If the full dynamic range of the detected signal plus noise of a 10 Hz geophone is digitized, the analog to digital converter (typically with 24 bit resolution) will be overwhelmed with the low frequency noise, with the actual seismic signal then having a lower resolution (and less precision) than would be the case if the noise were not present in the seismic signal. A further advantage is that a geophone with a resonant frequency of 20 Hz or higher will have a more linear output, because it is not creating harmonics of the low frequency noise. For example, 10 Hz noise will create big 2^{nd}, 3^{rd}, and 4^{th} harmonics at 20 Hz, 30 Hz and 40 Hz. For these reasons, it is highly advantageous to utilize a geophone with a higher resonant frequency, which acts as an analog filter to attenuate the strong noise at low frequencies before the seismic signal is digitized.

Any signal detected by a geophone in a marine seismic streamer in the frequency range below about 20 Hz can be expected to be primarily noise, and for that reason the geophone signal is typically filtered to eliminate frequencies below about 20 Hz before the geophone signal is combined with the hydrophone signal as further described herein. The geophone phase and frequency response will typically be matched to that of the hydrophone signal before combination with the hydrophone signal for deghosting.

In one embodiment, the particle motion sensor of the present invention is utilized in a method for combining signals of a pressure sensor and a particle motion sensor recorded in a marine seismic streamer, as described in U.S. Patent Application Publication No. US 2005/0195686 A1, of Svein Vaage et al., “System for Combining Signals of Pressure Sensors and Particle Motion Sensors in Marine Seismic Streamers”, published Sep. 8, 2005, with the co-inventors of the present invention, assigned to an affiliated company of the assignee of the present invention, and herein incorporated by reference. In this embodiment, the recorded pressure sensor signal has a bandwidth comprising a lower frequency range and a higher frequency range, with the recorded signal of the particle motion sensor of the invention having a bandwidth comprising at least the higher frequency range. A particle motion sensor signal is calculated in the lower frequency range from the recorded pressure sensor signal, thereby generating a simulated particle motion sensor signal in the lower frequency range. The simulated particle motion sensor signal is merged in the lower frequency range with the recorded particle motion sensor signal in the higher frequency range to generate a merged particle motion sensor signal having substantially the same bandwidth as the bandwidth of the recorded pressure sensor signal. The recorded pressure sensor signal and the merged particle motion sensor signal are combined for further processing.

An accelerometer can also be used in the invention as the particle motion sensor instead of a geophone. FIG. 3 shows the frequency response 31 of an accelerometer according to the present invention as a graph of sensitivity in dB versus frequency in Hz. If the same sensitivity as with the geophones is desired at 50 Hz, the attenuation at low frequencies will be as in FIG. 3. The slope of the frequency response 31 for the accelerometer, when plotted in velocity, shows an attenuation of 6 dB per octave at low frequencies. This means that an attenuation of 15-34 dB is obtained for frequencies in the range of 1-10 Hz. Thus, employing an accelerometer could also be a possible solution to the problem of attenuating noise in the particle motion sensor at low frequencies, but the accelerometer will not attenuate noise as well as the geophones will.

In a further embodiment, the particle motion sensor of the present invention is mounted in a marine seismic streamer in the manner described in U.S. Patent Application Publication No. 2005/0194201 A1, by Rune Tenghamn and Andre Stenzel, “Particle Motion Sensor for Marine Seismic Sensor Streamers”, published Sep. 8, 2005, and assigned to an affiliated company of the assignee of the present invention, and incorporated herein by reference. In this embodiment, a marine seismic sensor system includes a sensor jacket adapted to be towed by a seismic vessel through a body of water. A plurality of particle motion sensors, according to the present invention, are suspended within the sensor jacket at spaced apart locations along the jacket. Each of the particle motion sensors is suspended in the jacket by at least one biasing device. The mass of each particle motion sensor and a force rate of each biasing device are selected such that a resonant frequency of the suspension of each sensor within the sensor jacket is within a selected frequency range. The reduction in mechanical streamer noise from employing the suspension mounting means for the particle motion sensor in this reference compliments and augments the reduction in noise from employing the particle motion sensor of the present invention.

This beneficial response of the particle motion sensors of the invention provides for a higher signal-to-noise ratio in the recorded particle motion data and hence, in the combined pressure and particle motion data. This improved signal resolution will be advantageous in any further data processing in which the combined pressure and particle motion data are utilized. For example, the pressure data and the particle motion data may be combined to generate separate up-going and down-going wavefield components, which may then be processed further, as is well known in the art of seismic data processing. For example, the up-going wavefield component may be utilized to provide deghosted seismic data and to attenuate other unwanted multiple wavefields in the recorded seismic data.

In another embodiment, the invention is a method for marine seismic surveying. FIG. 4 shows a flowchart illustrating the steps of an embodiment of the method of the invention for marine seismic surveying.

In step 41, at least one marine seismic streamer is towed in a marine environment. Typically, many marine seismic streamers would be towed during a marine seismic survey.

In step 42, pressure data are acquired from at least one pressure sensor mounted in the at least one marine seismic streamer towed in step 41. Typically, many pressure sensors would be mounted within the many marine seismic streamers during a marine seismic survey. The pressure sensors may be mounted singly or in groups. The pressure sensors would typically comprise hydrophones.

In step 43, particle motion data are acquired from at least one particle motion sensor mounted in the at least one marine seismic streamer towed in step 41 and collocated with the at least one pressure sensor in step 42. The particle motion sensor is designed according to the present invention so that it has a resonance frequency above 20 Hz. Typically, many particle motion sensors would be mounted within the many marine seismic streamers and collocated with many pressure sensors during a marine seismic survey. The particle motion sensors may be mounted singly or in groups. The particle motion sensors would typically comprise geophones. In particular, a spring constant and a suspended inertial mass of the geophone are selected so that the combination yields the resonance frequency above 20 Hz. In an alternative embodiment, the particle motion sensors could comprise accelerometers.

In step 44, the pressure data acquired in step 42 and the particle motion data acquired in step 43 are combined for further processing, as is well known in the art of seismic data processing. For example, the pressure and particle motion data may be combined so as to generate deghosted marine seismic data. Techniques for combining pressure data and particle motion data to generate deghosted marine seismic data are well known in the art of marine seismic data processing.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents.

We claim:

1. A system for marine seismic surveying, comprising:
at least one marine seismic streamer;
at least one pressure sensor mounted in the at least one marine seismic streamer;
at least one particle motion sensor mounted in the at least one marine seismic streamer and collocated with the at least one pressure sensor,
wherein the at least one particle motion sensor has a resonance frequency above 20 Hz; and
computer means for combining pressure data from the at least one pressure sensor and particle motion data from the at least one particle motion sensor for further processing.

2. The system of claim 1, wherein the at least one pressure sensor comprises a hydrophone.

3. The system of claim 1, wherein the at least one particle motion sensor comprises a geophone.

4. The system of claim 1, wherein the at least one particle motion sensor comprises an accelerometer.

5. The system of claim 3, wherein a combination of spring constant and suspended inertial mass of the geophone are selected to yield the resonance frequency above 20 Hz.

6. The system of claim 5, wherein the resonance frequency is in the range of about 30 Hz to about 50 Hz.

7. The system of claim 1, further comprising:
computer means for calculating a particle motion sensor signal in a lower frequency range from the recorded pressure sensor signal, thereby generating a simulated particle motion sensor signal in the lower frequency range; and
computer means for merging the simulated particle motion sensor signal in the lower frequency range with the recorded particle motion sensor signal above the lower frequency range to generate a merged particle motion sensor signal having substantially the same bandwidth as the bandwidth of the recorded pressure sensor signal.

8. The system of claim 1, wherein the computer means for combining pressure data and particle motion data comprises computer means for generating up-going and down-going wavefield components.

9. A method for marine seismic surveying, comprising:
towing at least one marine seismic streamer;
acquiring pressure data from at least one pressure sensor mounted in the at least one marine seismic streamer;
acquiring particle motion data from at least one particle motion sensor mounted in the at least one marine seismic streamer and collocated with the at least one pressure sensor, wherein the at least one particle motion sensor has a resonance frequency above 20 Hz; and
combining the pressure data and the particle motion data for further processing.

10. The method of claim 9 wherein the at least one pressure sensor comprises a hydrophone.

11. The method of claim 9, wherein the at least one particle motion sensor comprises a geophone.

12. The method of claim 9, wherein the at least one particle motion sensor comprises an accelerometer.

13. The method of claim 11, wherein a combination of spring constant and suspended inertial mass of the geophone are selected to yield the resonance frequency above 20 Hz.

14. The method of claim 13, wherein the resonance frequency is in the range of about 30 Hz to about 50 Hz.

15. The method of claim 9, further comprising:
calculating a particle motion sensor signal in a lower frequency range from the recorded pressure sensor signal, thereby generating a simulated particle motion sensor signal in the lower frequency range; and
merging the simulated particle motion sensor signal in the lower frequency range with the recorded particle motion sensor signal above the lower frequency range to generate a merged particle motion sensor signal having substantially the same bandwidth as the bandwidth of the recorded pressure sensor signal.

16. The method of claim 9, wherein the combining the pressure data and the particle motion data comprises generating up-going and down-going wavefield components.
